(19) United States
(12) Patent Application Publication
(10) Pub. No.: US 2005/0042136 A1
(43) Pub. Date: Feb. 24, 2005

(54) Colorimetric gas detector and windowed process chamber

(76) Inventors: Paul J. Marganski, Seymour, CT (US); Joseph D. Sweeney, New Milford, CT (US); Glenn M. Tom, New Milford, CT (US); Jose I. Arno, Brookfield, CT (US); Thomas H. Baum, New Fairfield, CT (US); Jeffrey F. Roeder, Brookfield, CT (US); James R. Hills, Tigard, OR (US)

Correspondence Address: ATMI, INC., 7 COMMERCE DRIVE, DANBURY, CT, 06810, US

(21) Appl. No.: 10/642,848

(22) Filed: Aug. 18, 2003

(51) Int. Cl. G01N 21/00

(52) U.S. Cl. 422/58; 436/169

(57) ABSTRACT

A windowed chamber, e.g., a semiconductor manufacturing process chamber such as a scrubber, deposition chamber, thermal reactor, or the like, including a port with a radiation-transmissive window therein. Interiorly disposed within the chamber is (i) a disposable film on an interior surface of the window and/or (ii) a colorimetric medium disposed in viewable relationship to the window, so that a colorimetric change is perceivable through the window, e.g., visually or by optical sensing device, when the colorimetric medium is exposed to target gas species. Also disclosed is a gas detection article including a polymeric material that is colorimetrically responsive to the presence of at least one target gas species, in exposure thereto.

### BACKGROUND OF THE INVENTION

This invention relates to a colorimetric gas detector and windowed process chamber, as useful in facilities for the manufacture of semiconductor products.

### DESCRIPTION OF THE RELATED ART

In the manufacture of semiconductor products, it is common to utilize a wide variety of radiation signal-based analytical tools. The radiation may be of the visible light spectrum, or alternatively infrared (IR) or ultraviolet radiation (UV). The analytical instrument may operate on the basis of radiation reflection, absorption, refraction, transmittance or other modality that depends on the radiation being employed.

IR- and UV-based analytical tools are particularly widely used in semiconductor manufacturing facilities. Replacement parts for such analytical tools typically expensive, reflecting the high costs of such tools, and many such tools utilize protective windows that isolate the components of the analytical instrument from the active processing environment in the process chamber being monitored or analyzed. Since the window in such applications is interposed between the harsh environment of the processing chamber and the delicate and sensitive internal components and mechanisms of the analytical instrument, the windows are required to be chemically inert, to be non-absorptive of radiation in the spectral region of interest and unaffected by substantial changes in process conditions (e.g., temperature, pressure, etc.), during the active gas processing in the manufacturing process chamber associated with the analytical instrument.

Commercially available windows for the above-described applications typically are very expensive. Further, as a result of the harsh gaseous environments to which the window is exposed, and resultant fouling of the window surface through which radiation must pass for satisfactory operation of the analytical instrumentation, the window requires frequent cleaning and/or replacement. Such cleaning/replacement operations are generally labor-intensive and may involve significant down-time for the associated maintenance effort.

It would therefore be a substantial advance in the art to provide a windowed apparatus for semiconductor manufacturing operations, e.g., a semiconductor manufacturing process chamber in which cost and maintenance requirements associated with the window component is minimized.

In many semiconductor manufacturing process operations, acid gases, hydride gases, and various other hazardous and/or gases are used and/or produced, e.g., hydrogen chloride (HCl), boron trichloride (BCl₃), boron trifluoride (BF₃), hydrogen fluoride (HF), arsine, phosphine, silane, alkylsilanes, germane, stibine, boranes, etc. Prior to venting of the effluent of such semiconductor manufacturing operations to the atmosphere, it is necessary to treat the effluent gas to remove acid gases and hydride gases, as well as other toxic, corrosive, flammable, or otherwise hazardous species of the effluent gas, to below levels mandated by applicable statutes and regulations.

A wide variety of processes and effluent treatment apparatus are conventionally employed to remove acid gases and other target gaseous species from effluents containing same. Process equipment conventionally employed for such effluent gas treatment may include wet scrubbers, dry scrubbers, thermal reactors, etc. In the use of such effluent treatment equipment, it is desirable to monitor the process to ensure that the abatement system is operating as intended, e.g., by monitoring the exhaust of the scrubber or other gas treatment unit to ensure that required removals of gaseous species are being achieved, consistent with applicable constraints on final effluent contaminant levels.

Considering the treatment of effluent by scrubbers in further detail, it is common in semiconductor processing to scrub the effluent from an ion implant unit or a chemical vapor deposition chamber with a fixed bed adsorption device that utilizes chemisorption to irreversibly remove the target species from the effluent. Typical effluent gases include arsine, phosphine and boron trifluoride, as well as gaseous reagents such as germanium, antimony and indium compounds. A major issue with such fixed bed effluent treatment units is determining exactly when the bed of sorbent medium has been spent.

Typically, an extractive sensor device is used to monitor the effluent, e.g., expensive monitoring devices such as electrochemical sensors, analytical instruments, etc., which involves the use of disposable tapes and electrochemical cells. The tapes and electrochemical cells have to be changed out frequently, resulting in required maintenance by the end user.

It would therefore be a significant advance in the art to provide a monitoring means and technique for effluent gas treatment operations, which avoids the cost and complexity of using electrochemical sensors, analytical instruments, and similar conventional monitoring devices.

Additionally, there is a generalized need for a quick-action indicator that is of low cost as a detection element for sensing of toxic gases. Relevant applications for such quick-action indicators include badge sensors, sensor module disposable indicator elements, test strips for valves and fittings (to ascertain whether leakage has occurred or is occurring) and general environmental monitoring. Toxic gases that are involved in such applications include toxic hydride species, e.g., arsine, phosphine, and other metal hydride species, as well as corrosive gas species, including HCl, HF, etc.

Currently available electrochemical cells do not leave a permanent record after exposure to the target gas species. This lack of permanent indicator capability has limited the use of such cells in monitoring applications such as those mentioned in the preceding paragraph. Additionally, very low levels of the target gas species may be below the detection limit of the electrochemical cell sensor, yet such gas levels may be sufficiently high to constitute a concern for long-term exposure and reliability of the sensor.

The art therefore has a continuing need for a quick-action sensor that is permanently indicative of the presence of target gas species in the monitored gas environment.

### SUMMARY OF THE INVENTION

The present invention relates to a colorimetric gas detector and windowed process chamber, e.g., for use in semiconductor manufacturing facilities to detect presence of one or more target gas species in a gaseous environment, as well as to associated methodology.

In one aspect, the invention relates to a windowed chamber comprising a radiation-transmissive window, and interiorly disposed within the chamber at least one of:
a radiation-transmissive protective film on an interior surface of said window, and
a colorimetric medium disposed in viewable relationship to said window, wherein the colorimetric medium undergoes a color change in the presence of target gas species.

In another aspect, the invention relates to a monitoring instrument having a radiation-transmissive window for transmission therethrough of radiation from a monitored environment. The monitoring device includes circuitry for processing of radiation transmitted through the window and generating a correlative output, such window having on a surface thereof exposed to the monitored environment in operation thereof, a radiation-transmissive protective film that is selectively removable from the window.

A further aspect of the invention relates to a colorimetric indicating assembly for colorimetric detection of target gas species in a gaseous environment containing same, such assembly comprising a viewing window having disposed in viewable relationship thereto a colorimetric medium that in exposure to the target gas species changes color.

Yet another aspect of the invention relates to a method of reducing maintenance of a windowed port exposed to a gaseous environment on a first surface of a window, such method comprising providing a protective film on the first surface of the window, such protective film being selectively removable from the window surface.

Another aspect of the invention relates to a method of monitoring a gaseous environment for detection of a target gas species therein, such method comprising disposing a viewing window in viewing relationship to the gaseous environment and disposing a colorimetric medium in the gaseous environment in viewable relationship to the window.

A still further aspect of the invention relates to a gas detector assembly including a sheet-form element, e.g., paper, that is impregnated with a colorimetric medium that responsively changes color in exposure to one or more target gas species, and means for detecting such color change when the sheet-form element has changed color in exposure to such one or more target gas species.

The invention in another aspect relates to a gas detection article comprising a polymeric material that is colorimetrically responsive to presence of at least one target gas species, whereby exposure of the polymeric material to such at least one target gas species causes a color change of the polymeric material.

Another aspect of the invention relates to a method of detecting the presence of one or more target gas species in an environment susceptible to the presence of such gas species, in which the method involves exposing to such environment a gas detection article comprising a polymeric material that is colorimetrically responsive to presence of at least one target gas species, whereby exposure of the polymeric material to such at least one target gas species causes a color change of the polymeric material.

Yet another aspect of the invention relates to a method of detecting the presence of one or more target gas species in an environment susceptible to the presence of such gas species, in which the method involves disposing a sheet-form element in the environment, wherein the sheet-form element is impregnated with a colorimetric chemistry that is effective to change color of the sheet-form element when the impregnated sheet-form element is exposed to the one or more target gas species.

Still another aspect of the invention relates to a window exposed to a gaseous environment susceptible to incursion of target gas species in use, such window having on a surface thereof exposed to the gaseous environment a removable protective film having a colorimetric medium associated therewith, wherein the colorimetric medium undergoes a color change in exposure to the target gas species.

Other aspects, features and embodiments of the invention will be more fully apparent from the ensuing disclosure and appended claims.

### DESCRIPTION OF THE DRAWINGS

FIG. 1 is a schematic representation of a windowed port of a semiconductor manufacturing process chamber, including a window interposed between a gaseous environment in the chamber, and instrumentation employed to monitor the process chamber.

FIG. 2 is a front elevation view, and FIG. 3 is an exploded side elevation view, of a colorimetric cartridge-equipped port of a semiconductor manufacturing process chamber.

FIG. 4 is a schematic representation of an electrochemical cell featuring a colorimetric indicator element according to one aspect of the invention.

FIG. 5 is a schematic representation of a gas detection module including an array of electrochemical cells and a photodiode/colorimetric indicator element assembly, in accordance with another aspect of the invention.

### DETAILED DESCRIPTION OF THE INVENTION, AND PREFERRED EMBODIMENTS THEREOF

The present invention relates in one aspect to a windowed chamber, e.g., a semiconductor manufacturing process chamber for containment of a gaseous or other fluid environment, in which the chamber includes a windowed port constructed and arranged for enhancing process and maintenance efficiency of the chamber.

In accordance with such aspect of the invention, a windowed semiconductor manufacturing process chamber is provided, including a window port comprising a radiation-transmissive window, and having interiorly disposed within the chamber at the window port at least one of: (i) a disposable protective film on an interior surface of the window, and (ii) a colorimetric medium disposed in viewable relationship to the window.

The disposable protective film on the interior surface of the window is usefully employed where the window is interposed between a gaseous environment of the process chamber and analytical or monitoring instruments that rely on light or other radiation being transmitted through the window to the analytical or monitoring instrument. Examples include FT-IR units and UV-VIS spectrometers, having radiation-transmissive windows that are susceptible to contamination in exposure to the gas being monitored, and which can be readily protected by the deployment of disposable film patches in accordance with the present invention.

The film disposed on the interior surface of the window desirably is of a thin, chemically-inert, radiation-transmissive character. The film is appropriately non-absorbing of the radiation transmitted through the window in the normal operation of the process gas chamber and associated analytical/monitoring instrument, i.e., the film therefore is transmissive of radiation in the spectral region of interest to the associated instrumentation. Such spectral region of interest may reside in the visible spectrum, infrared spectrum, or ultraviolet spectrum.

In specific embodiments, the protective film is non-absorbing of infrared or UV light, as appropriate to respective infrared or UV monitoring systems. The film desirably is of an appropriately gas-resistant character with respect to the gaseous environment within the process chamber (e.g., not susceptible to rapid degradation in exposure to the gases in the process chamber with which the film is contacted during the use of the film, chemically non-reactive with the gaseous species in such environment, etc.). For example, in the case of acid gas environments, the film material is appropriately selected to be substantially impervious to attack by acid gases, to an extent determined by the desired service interval and anticipated operating life of the film. Film materials that can be usefully employed in the broad practice of the present invention include, by way of illustration, visible and UV-transmissive materials such as acrylics, vinyls, silicones, polycarbonate, polysulfone, acetates, styrenes, etc., and IR-transmissive materials such as those commercially available from Fresnel Technologies, Inc. (Fort Worth, Tex.) under the trademark POLY-IR®.

The protective film can be of any suitable type that is readily removable from the window surface and easily disposable, to enable a simple and efficient technique for cleaning the window, by removal and disposal of the protective film following active operation of the process chamber, e.g., after a predetermined period of use or after fouling of the film by the gaseous environment indicates the need for film replacement.

The film can be of a pre-formed sheet or web that is cut to a size appropriate for the window and then affixed to the window surface. The film can be affixed by a radiation-transparent adhesive medium, such as a low-tack adhesive, e.g., acrylic adhesives, silicone adhesives, vinyl adhesives, etc., or the film itself may be provided with an adhesive character, such as MAGIC® CLEARTAK optically clear mounting film commercially available from Intelicoat Technologies (South Hadley, Mass.) and SUPERCLING® low tack vinyl commercially available from Plastiprint, Inc. (Lakewood, Colo.). It will be appreciated that a wide variety of film types and adhesive media may be employed in the broad practice of the present invention.

The adhesive can be applied over the entire facial area of the protective film element, or alternatively the protective film element may be provided with adhesive only at its periphery, which permits the use of adhesive media that are not radiation-transmissive or that otherwise diminish the transmissivity of the protective film element, when applied over the full areal extent of the film surface.

As an alternative to adhesive attachment of the protective film to the window, the film may be overlaid on the interior window surface and be sized larger than the window so as to have a peripheral margin. A retaining frame element then can be secured over the peripheral margin of the film, to secure the film in place, overlying the window. As a specific example, the window can be of circular shape and the protective film can likewise be of circular shape with a larger diameter than the window, so as to produce an annular margin circumscribing the outer edge of the window. A porthole retaining ring can be positioned over the annular margin of the film and affixed to the process chamber wall, e.g., being secured in place by mechanical fasteners, quick-disconnect coupling elements, or other securement means. By this arrangement, the porthole ring presents a bearing surface to the annular margin of the film, for compressively retaining the protective film in place over the inner surface of the window.

As another modality for disposing the protective film on the interior surface of the window, the interior window surface may be chemically treated or functionalized, e.g., with amine functional groups by amination reaction with the window surface, or with silyl groups by silylation of the surface using silane coupling agents, to enhance associative bonding of the film to the window interior surface. In such instances, the film material is appropriately selected to maximize the associative bonding affinity for the substrate window functionalized surface.

As a further alternative, the protective film may be of a form-in-place type, such as may be coated on the port window from a resin solution or other precursor formulation. For example, a solvent solution of resin material can be applied to the interior surface of the window and permitted to dry (e.g., by air-drying or oven drying) to release solvent from the wet film material, and produce a corresponding dry film of the resin on the interior window surface. The application of the precursor formulation may be carried out in any suitable manner, such as by dip-coating, roller-coating, spraying, brushing, etc., to apply the formulation to the window surface at a predetermined wet film thickness to form the product film on the window surface.

The protective film when applied by a form-in-place procedure from a precursor formulation will be applied at a wet film thickness appropriate to the solids level of the formulation, to produce the dry film of desired thickness and character. Typically, the precursor formulation will comprise a volatile solvent and the solids level of the formulation may range from 5% to levels approaching 100%. In the event that the precursor formulation is a self-leveling material of 100% solids character, no solvent is required, and the film can be cured or hardened as appropriate to the material involved. For example, a 100% solids self-leveling formulation can be applied to the window surface, and thereafter the applied film can be cross-linked by actinic radiation exposure, heating of the film to a cure temperature, etc., to produce a hardened product film of the desired character.

The protective film should be of sufficient thickness to provide a hole-free continuous film overlying the window surface. Protective film thicknesses usefully employed in specific embodiments of the invention include film thicknesses in a range of from about 2 mils to about 100 mils, with thicknesses in a range of from about 2 to about 40 mils being preferred and thicknesses in a range of from about 2 to about 10 mils being most preferred.

The protective film once applied should be readily removable in character. If applied by a low-tack adhesive, the film will be readily manually removable, e.g., as a peelable film. The film preferably is of a peelable character, although in some embodiments, it may be suitable to remove the film by solvent exposure, such as may produce a swelled film that is readily manually removable, or the film may be removed by dissolution in an applied stripping solvent. In some instances, it may be desirable to heat the film material, e.g., to a softening temperature, or otherwise to impose conditions that facilitate film removal, e.g., exposure to liquid CO₂ or liquid nitrogen, to fracture the film or otherwise delaminate same from the window surface, optionally with assistive mechanical removal, e.g., with a blade of a razor knife applied to the film to abradingly or shearingly remove same from the window surface.

As yet another removal modality, if the film is retained in place by a frame or press-fit element overlying the margin of the protective film, with the frame extending outwardly beyond the periphery of the window, the frame element can simply be removed, and the film material then can be removed from the window and discarded.

After removal of the film, after it has become fouled in use, or it has been in service for a predetermined time interval, a new film can be applied to the window surface. Prior to installation of the new film, the window surface can be solvent wiped or otherwise rinsed or washed, and the new film can then be applied in any suitable manner.

By use of the protective film in accordance with the present invention, the surface of the window in exposure to the gaseous environment of the process chamber is protected from being fouled, stained or otherwise degraded by the gaseous environment in the chamber, and the change-out of the protective film is easily and inexpensively carried out, relative to conventional window cleaning and replacement operations.

In another embodiment of the invention, a chemically-inert, non-radiation absorptive gel material can be utilized to coat the interior window surface, and form a protective film on such surface. The gel coat may be left in place on the window surface in the form in which it is originally applied, or it can be subjected to further processing operations such as cross-linking, hardening, etc., appropriate to the specific gel material employed.

Additional modes of securing the protective film to the interior window surface include static charge retention, friction fitting, and the like. As a specific example, the protective film may be of a heat-shrinkable polymeric character. A section of heat-shrinkable film may be cut to appropriate size, overlaid on the interior window surface and then subjected to heating, to heat-shrink the film onto the window surface.

It will be recognized at the foregoing description is of an illustrative character, and that the invention contemplates the utilization of a wide variety of protective films and materials, and a corresponding wide variety of securement and removal techniques.

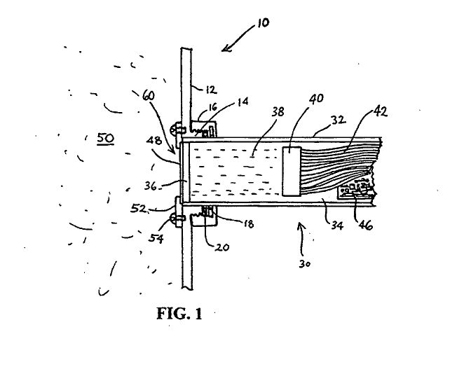

FIG. 1 is a schematic elevation view of a windowed port of a semiconductor manufacturing process chamber, according to one embodiment of the invention.

FIG. 1 depicts a windowed semiconductor manufacturing process chamber 10, wherein the chamber wall 12 bounds an enclosed interior volume 50 containing a gaseous or other fluid medium. The chamber wall 12 has a port opening 60 therein, bounded by port flange extension 14, which is threaded on its exterior surface, as shown.

Disposed in the port opening 60 is an analytical instrument 30, comprising a tubular body 32 enclosing an interior volume 34 containing an optoelectronic monitoring assembly including light sensor element 40 presenting the front face of a bundle 42 of optical fibers for impingement of radiation 38 thereon, as received from the interior volume 50 of the chamber, by transmission of such radiation through window 36 at the distal end of the tubular body 32. In accordance with the present invention, the window 36 is overlaid with a protective film 48.

The optoelectronic assembly in the analytical instrument 30 includes an electronics module 46, arranged to receive light from the bundle 42 comprising optical wave guide fiber elements, whereby radiation impinged on the front face of the bundle at light sensor element 40 is transmitted to optoelectronic conversion circuitry for signal processing, which can involve deconvolution and filtering of the optical data, time-averaging of optical signals, conversion of optical input to a visual or quantitative numerical output, etc.

The tubular body 32 of the analytical instrument 30 thus is fixtured in the port opening 60, and is secured in place by threadably engagable cap 16 that is mounted for rotation on circumferential rib 18 on the exterior surface of the tubular body 32. The cap 16 is threaded on its interior surface for matable engagement with complimentary threading on exterior surface of the port flange extension 14. For purposes of sealing the tubular body 32 of the analytical instrument in place, an O-ring element 20 is disposed between the cap and outer face of port flange extension 14, as shown.

The protective film 48 is disposed on the interior surface of the window (viz., the surface of the window closest to the gaseous environment 50) and is maintained in position by means of fixture ring 52. The fixture ring 52 is arranged with threaded openings receiving threaded mechanical fasteners 54 therein, and the interior surface of the chamber wall at the port opening is tapped and threaded to receive the distal end of such mechanical fasteners 54 therein. By this arrangement, the fixture ring 52 compressively retains the protective film 48 in position on the interior surface of the window 36.

The windowed process chamber system shown in FIG. 1 is readily assembled and disassembled to change out the protective film 48 after a predetermined period of service, or when same has become fouled or otherwise sufficiently used to merit replacement. Such arrangement permits the protective film to be employed as a disposable element that is readily applied and removed from the interior window surface, to enable the window surface to be protectively isolated from the gaseous environment 50 within the chamber during normal operation, and maintenance of the window to entail a simple removal of the used film and installation of a new replacement film. The protective film thereby achieves a substantial advance in the art, over the prior practice of continuing use of the window until same has become fouled or otherwise non-transmissive of radiation, followed by cleaning to remove deposits from the window surface, or replacing of the used window.

The protective film of the invention can be compositionally selected for the gaseous environment, so that fouling is minimized in relation to the fouling that would occur if the interior window surface were directly exposed to the gaseous environment. By judicious choice of film material, a longer period of operation can be achieved before a maintenance event occurs or is necessary, relative to operation using a window whose surface is not protectively shrouded with a protective film in accordance with the invention.

The invention also contemplates a windowed process chamber including a port comprising a radiation-transmissive window therein, having interiorly disposed within the chamber at the windowed port a colorimetric medium disposed in viewable relationship to the window.

Such aspect of the invention is particularly suited to monitoring of effluent abatement systems at the outlet portion of the process chamber, to verify that none of the gaseous species being abated from the effluent has “broken through” into the gas discharged from the effluent treatment chamber.

For such purpose, the windowed port for viewing of the colorimetric medium may be positioned at a discharge end of the process vessel, or in a discharge line coupled with the vessel for discharging treated gas therefrom.

The process chamber for such purpose may be of any suitable type, as adapted for effluent treatment or other industrial gas-phase reactions or processing. The invention in one embodiment utilizes a scrubber as the process unit being monitored, wherein the windowed port is positioned to monitor the exhaust of the scrubber vessel to ensure that the required removal of target gas species is being achieved.

The colorimetric medium is of any suitable type that in exposure to one or more target species of the gas undergoes a color change that is visually discernable by observation through the window of the chamber. The colorimetric medium thus reacts with the target gaseous species and changes color. Such colorimetric (color-changing) response to the target gas species may for example utilized to indicate when a scrubber is exhausted or approaching fully consumed status with respect to the dry scrubber medium in the vessel.

More generally, a colorimetric medium may be disposed in viewable relationship to a windowed port, in accordance with the invention, to provide a quick indication that a process unit is not properly operating, and that a target gas species is not being abated, reacted, or otherwise processed in the unit as intended.

Concerning dry scrubbers comprising a gas treating vessel containing a bed of particulate scrubbing medium through which gas is flowed for removal of target gas species therefrom, some scrubber media materials exhibit a color change that is indicative of reaction or interaction with the target gas species. It is within the purview of the present invention to utilize as the colorimetric medium a portion of such scrubbing material, however it is particularly preferred if the colorimetric indicating medium disposed in proximity to the windowed port of the process chamber is different from the active processing medium, i.e., the colorimetric medium does not comprise the scrubbing medium being employed to treat gas in the scrubber vessel.

Examples of colorimetric media that may be employed in the broad practice of the present invention, in specific embodiments, include, in the case of acid gases as target species, iron oxide, calcium hydroxide, copper sulfate, copper hydroxide, copper carbonate and the like. The colorimetric medium may be based on any suitable chemistry with respect to the particular target gas species involved.

The colorimetric medium may be presented or packaged in any suitable manner, in respect of the windowed port of the process chamber with which the colorimetric medium is used. One advantageous form of the colorimetric medium is a colorimetric cartridge that provides a unitary package for ready installation in, and ready removal from, the interior volume of the process chamber.

In one embodiment, a colorimetric cartridge may be formed by impregnating a porous or adsorbent film, sheet or web with the chemistry that is specific to the target species of interest. For example, the substrate impregnated with the chemistry may comprise a porous paper, polymeric film, woven or non-woven fibrous pad, etc. The chemistry may be applied to a substrate article in solution or other appropriate form, to yield the colorimetric element. In one preferred embodiment, a porous paper or film is impregnated with the chemistry by absorption from a wet chemistry medium that is applied to the paper or film, and then dried, e.g., under ambient conditions or at elevated temperature. The dried paper or film then is cut to appropriate shape, and placed inside suitable cartridge packaging, to form a colorimetric cartridge that can be readily installed in the chamber in proximity to the window, for visual verification of presence of target gas species in the gas environment being monitored.

As a further alternative, the active chemistry may be coated on adsorbent solids that function as a carrier or substrate for the colorimetric indicating medium. The adsorbent solid substrate may comprise a material such as molecular sieve, silica, alumina, clays, macroreticulate polymers, etc., in any suitable form, e.g., finely divided or discontinuous forms such as pellets, rings, particles, extruded geometric (regular or irregular) shapes, etc.

In use, the colorimetric medium as suitably packaged or presented may be disposed in viewable proximity to the windowed port of the process chamber, at a position where contact of the colorimetric medium with the target species of interest will produce a color change that is visually observable at the viewing port window.

As a further modification, a colorimetric sensing device may be disposed exteriorly of the process chamber, and arranged to detect the colorimetric change incident to exposure of the colorimetric medium in the chamber to a target species. For example, such external colorimetric sensing device may be optoelectronic, or otherwise constituted to detect the color change and responsively produce a correlative output indicative of the presence of the target gas species at the locus of the colorimetric indicating medium in the process chamber.

A simple gas detector assembly thus may be provided in accordance with the invention, including a sheet-form element, e.g., paper, that is impregnated with a colorimetric medium that responsively changes color in exposure to one or more target gas species, and means for detecting such color change when the sheet-form element has changed color in exposure to such one or more target gas species. The means for detecting the color change can be of any suitable type, e.g., a window through which the color change is visually perceivable, or a sensor or monitor arranged to optically, optoelectronically or by other modality respond to the color change by recording same, initiating an actuation operation, producing an alarm or other signal output, or any other apparatus or mechanism that is affected by the color change to produce a response indicative of the presence of the one or more target gas species.

The invention thus permits a ready method of detecting the presence of one or more target gas species in an environment susceptible to the presence of such gas species, by disposing in the environment a sheet-form element impregnated with a colorimetric chemistry that undergoes color change when the impregnated sheet-form element is exposed to the one or more target gas species.

For example, such a chemically treated paper can be placed in a semiconductor manufacturing environment to change color upon contact with effluent gases, as a method for determining breakthrough of such effluent gases within a fixed bed adsorption system. The paper can be attached to a window that is placed at a location such that it would indicate when 90% (or other predetermined fraction) of the bed has been spent.

The paper impregnated with the chemistry can be any appropriate absorbing material such as paper formed of cellulosic fibers, or other natural or synthetic fiber material. In application to detection of hydride gases, the paper can be immersed in an impregnant aqueous solution of copper sulfate (CuSO₄). The paper treated in such manner then is dried. The dried paper retains the absorbed copper sulfate and has a pale blue color. When the impregnated detector paper prepared in such manner is exposed to hydride gases (e.g., arsine, phosphine, diborane, germane, etc., the paper changes color, from a bluish-white color to a deep brown/black color.

The hydride detection paper element prepared in such manner can be deployed for exposure to a gas environment susceptible to the presence of the target hydride gas(es) in any suitable manner. The paper may be placed in a housing or container with the paper in gas-contacting relationship with the gaseous environment being monitored for the presence of the hydride gas(es) of interest, with the paper element being arranged for observation or sensing of the color change with suitable color-change sensing means.

In application to a fixed bed dry scrubber unit, the paper impregnated with the colorimetric chemistry can be placed on an inside surface of a view port (window) that is welded or otherwise attached to the fixed bed unit, so that the paper detection element is in contacting relationship with gas in the bed at the location of the view port. When the hydride gas being abated by the fixed bed of dry scrubber material breaks through at the location of the paper detection element, e.g., 90% of the axial distance through the bed, as measured from the inlet end of the bed, the axial direction being the direction of gas flow through the bed, the break-through hydride gas(es) will react with the colorimetric chemical, viz., CUSO₄, turning the paper from pale blue to black, thereby providing an indication that the bed has been spent.

Monitoring of the paper for such color change can be performed either manually (visually) or using spectroscopic methods.

As an alternative to the use of a paper element as a support for the colorimetric chemistry, a resin such as a molecular sieve, or other substrate or support material, could be impregnated with CUSO₄ and used as the colorimetric detection element. Any suitable element, medium or article with which the colorimetric chemistry can be impregnated, applied or otherwise associated may be usefully employed for such purpose.

In general, any suitable colorimetric chemistry can be employed that is effective to produce a color change in exposure to the target gas species.

The invention in another aspect contemplates the detection of more than a single species of target gas, and the detection of multiple families of gases (e.g., multiple acid gases, multiple hydride gases, or one or more gas species of different gas families, such as acid gases and hydride gases, or hydride gases and fluorine-containing gaseous compounds, or other disparate gas species). Such multi-species and/or multi-family gas detection is applicable to the monitoring of abatement processes that treat multicomponent effluent gas streams containing a number of discrete gas species that must be removed prior to final discharge of the treated effluent from the processing facility.

In application to the detection of gas species of differing type and/or family, a suitable support material or medium can be impregnated with or otherwise be associated with the colorimetric chemistry. For ease of convenience and for minimizing cost, paper substrate elements are usefully employed, and may as described above, be readily impregnated with the colorimetric chemistry. The paper can be soaked in any chemistry that sufficiently changes color in contact with the target gas species.

Concerning color chemistries applicable to such multi-species detectors, chemistries such as copper sulfate and copper carbonate can be used for detecting hydride species such as arsine. For detection of acid gas species, materials such as iron oxide, pH indicating solutions, copper carbonate, copper hydroxide, etc., are usefully employed.

Considering process applications of such multi-species detectors, in ion implantation, three main gases are conventionally used that require effluent treatment—arsine, phosphine and boron trifluoride. A copper sulfate detector is effective to indicate the presence of hydride gases but will not change color in contact with boron trifluoride or its by-product hydrogen fluoride. The iron oxide chemistry or other acid gas indicator will detect the fluoride gases, but not hydride species.

In order to accommodate such limitations of individual chemistries, the invention encompasses the concurrent use of multiple chemistries. For example, the paper element, e.g., of filter paper or other suitable support element is chemically impregnated with multiple chemistries.

In one illustrative embodiment, the paper element is impregnated with a solution of copper sulfate for detection of hydride gases and also impregnated with a pH indicator (e.g., cresol red) for the detection of acid gases. Such CuSO₄/cresol red combination is useful for many ion implant applications. Other colorimetric chemistry combinations include copper sulfate with any other pH indicator, copper carbonate with a pH indicator, copper hydroxide with a pH indicator, etc. Common pH indicators include cresol red, methyl red and crystal violet.

As an alternative means of detecting multiple target gas species, a “split-window” technique may be employed, involving physical separation of the respective chemistries for the respective ones of the multiple species being monitored. For example, a paper element can be soaked half-way across its surface with a hydride detection chemistry such as copper sulfate in aqueous solution, with the other half of the surface being soaked with a pH indicator, so that different areal portions of the paper are devoted to different chemistries. Such approach is usefully employed in the case of chemistries that cannot be mixed with one another.

In other instances, the colorimetric chemistries for the multiple components can be mixed with one another on the paper or other support medium, and the constituent color changes can be monitored, against calibration or correlation standards that permit the specific components breaking through to be established. This may be advantageous, for example, in instances where polishing or other post-treatment abatement processing is employed, and the breakthrough of one species is independent from the breakthrough of another. In such case, the initial breakthrough species can be abated in a downstream treatment unit during the transition toward breakthrough of the other species.

When the color change indicative of the presence of the target gas species occurs, the color change is detected in any suitable manner, e.g., by visual inspection, or, more preferably, by an optical sensor. Many models of optical sensors are commercially available, and usefully employed in the broad practice of the present invention (e.g., MDA sensors, commercially available from Zellweger Analytics, Inc. (Lincolnshire, Ill.), and sensors commercially available under the trademarks ISA and SPECTRUM from Enmet Corporation (Ann Arbor, Mich.)). The sensor is suitably positioned for monitoring the color change of the indicating element. Under “normal” conditions (absence of target species in the gas contacted with the indicating element), the sensor sends out a baseline signal. When the indicating element changes color, the sensor's output signal will change as a result of the difference in the absorbance of light from the indicating element. When the sensor signal reaches a predetermined level, reflecting the presence of the target species in the gas being monitored, an alarm can be latched in associated circuitry, to produce an alarm output indicative of chemical breakthrough of the target gas species.

As a further aspect of the invention, colorimetric chemistry can be impregnated in a disposable protective film element that is removably applied to a viewport window, e.g., on an interior surface of such a window in a viewport at the effluent end region of a fixed bed scrubber unit. After the colorimetric change of the film element, the film is readily peeled off the window, and replaced with a fresh protective film element containing the colorimetric chemistry. Such film elements can therefore be provided in standard viewport window sizes, and packaged on a release sheet, e.g., coated with polytetrafluoroethylene film, as a disposable article for use in window-fouling gas environments susceptible to incursion of chemical species for which the viewport window film is colorimetrically sensitive.

Such a color-indicating protective film can be formed as a patch or disk that is self-adherent to the window surface, or capable of being secured to the window, e.g., by a low-tack transparent adhesive, or by a porthole flange element overlying the protective film element at its periphery to compressively retain it in position, or in other suitable manner.

As a specific example of such color-indicating protective film, the film may be a solvent-cast film, such as a polyvinylalcohol (PVA) film, polyvinylchloride (PVC) film, polycarbonate film, polyimide film, etc. that is cast from a solution or dispersion of the polymer resin in a suitable solvent, e.g., aqueous medium such as water, organic solvents such as acetone, aniline, dimethyl sulfoxide (DMSO), benzene, dimethyl formamide (DMF), methyl ethyl ketone (MEK), ethyl acetate, ethylene dichloride, toluene, and tetrahydrofuran (THF), etc. The colorimetric chemistry can be incorporated in the solvent casting formulation, so that the colorimetric chemistry is present as a component of the product film, or alternatively the film may be formed by solvent casting and the colorimetric chemistry can be applied to the deposited film, either as a wet film or as a subsequently dried film, so that the colorimetric reagent(s) are incorporated into the film material and thereafter function to colorimetrically indicate the presence of the target gas species to which the film is colorimetrically sensitive.

As a further specific example, a PVA film can be cast from a solution of PVA in diethyl ether or acetone, to which copper sulfate has been added, with such precursor solution containing 15-20% by weight of PVA, based on the total weight of the solution, at sufficient wet film thickness to produce a dry film of 5-6 mils thickness. The film can be cast on a low surface energy substrate, e.g., a substrate coated with polytetrafluoroethylene, permitting the PVA film impregnated with the CuSO₄ hydride gas colorimetric indicator to be peeled from such substrate.

The resultantly separated free-standing film then can be placed on the interior window surface of a viewport of a scrubber unit, and pressed to the window surface to effect an adherent contact with the window material of construction, or alternatively, the film can be compressively secured in position by a porthole window frame of the viewport, or otherwise secured in place using a low tack transparent adhesive.

In use, the film will colorimetrically indicate the breakthrough of hydride, e.g., arsine gas, from the fixed bed in the scrubber vessel, by color change from bluish-white to black. An optical sensor arranged to generate a light beam for impingement on the window and to sense a reflected radiation beam to determine change in absorbance of the incident radiation can be deployed to actuate an alarm or other output correlative of the colorimetric change.

The scrubber can then be taken off-line for change-out of the scrubber medium, and concurrent change-out of the “used” colorimetric indicating film. The film is removed by peel-off from the window, optionally with aid of solvent or cleaning medium for de-adhering the film, or alternatively by mechanical shearing removal or in other suitable manner, with the removed film being discarded, and replaced with a new colorimetric indicating protective film. In such manner, a simple means of colorimetric indication is employed, as a disposable article, which serves in use to protect the window surface from fouling and contamination, and thereby extends the operating life of the window.

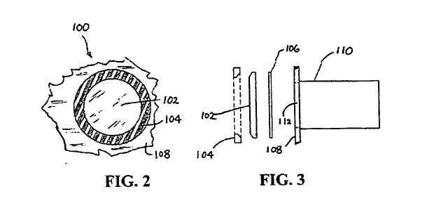

Referring again to the drawings, FIG. 2 is a front elevation view, and FIG. 3 is an exploded side elevation view, of a windowed semiconductor manufacturing process chamber 100 in accordance with a specific embodiment of the present invention.

The chamber comprises a viewport window 102 that is positionally retained on the wall 108 of the process chamber by a fixturing ring 104, which is secured to the wall 108 by suitable fixturing means, such as clamps, screws, coupling members, latches, matable keying structures, threadably engagable elements, etc. In one embodiment, the process chamber wall 108 may be associated with a pipe stub 110 or other suitable passageway, through which gas can pass to contact the colorimetric paper element 106 impregnated with the colorimetric chemistry, without damage to the paper deriving from conditions in the process chamber. For example, the pipe stub 110 may be employed in a scrubber vessel, to prevent any fines or particulate matter from contacting or depositing on the colorimetric paper element 106.

The pipe stub 110 may protrude from the process chamber and terminate in a flange constituted as the relevant wall portion, to which the colorimetric paper element 106 is fitted and overlaid by the viewport window 102 and fixturing ring 104. In such embodiment, a flange clamp can couple the fixturing ring 104 with the flange wall 108. The colorimetric paper element 106 in the arrangement shown in FIG. 3 thus is reposed over port opening 112 in wall 108 of the process chamber, and in turn is overlaid by the viewport window 102 to provide a visual observation port assembly, as shown in FIG. 2.

Such arrangement allows the colorimetric paper element to be in contact with the process gas, and to be continuously viewed by the operator of the process chamber, while concurrently isolating the operator from any toxic or otherwise hazardous gases that may be present in the process chamber.

The colorimetric medium thus can be deployed in a form comprising a suitable colorimetric chemistry, or any other suitable form that is positionable in viewable relationship to the windowed port and operative in such position to indicate the presence of a target gas species. The colorimetric element can be presented and deployed in any of a wide variety of suitable forms, e.g., sheets, web forms, capsules, ampoules, sachets, cartridges, granular matrices, packets, lozenges, etc., as appropriate to the specific arrangement of the windowed chamber within which the colorimetric medium is to be deployed.

The invention in another aspect contemplates a gas detection article comprising a polymeric material that is colorimetrically responsive to presence of at least one target gas species, whereby exposure of the polymeric material to such at least one target gas species causes a color change of the polymeric material.

Such gas detection article can be advantageously used in a method of detecting the presence of one or more target gas species in an environment susceptible to the presence of such gas species, in which the method involves exposing to such environment a gas detection article comprising a polymeric material that is colorimetrically responsive to presence of at least one target gas species, whereby exposure of the polymeric material to such at least one target gas species causes a color change of the polymeric material.

The gas detection article may comprise a polymeric material in the form of a free-standing structural element, e.g., a free-standing (unsupported) film, as a strip or tape, or in a finely divided form, such as beads, pellets, rings, or other geometrically regular or irregular shapes. The polymeric material in such form may itself undergo a color change in exposure to the target gas species, or alternatively the polymeric material may be impregnated or formulated with a colorimetric agent that causes a change of color of the polymeric material when exposed to such target gas species.

For example, the gas detection material may comprise beads of poly(vinyl pyridine), as commercially available from Aldrich Chemical Co., for use in detection of tris(trifluoromethyl)stibine as the target gas species. In contact with tris(trifluoromethyl)stibine, the beads of poly(vinyl pyridine) change color from their native yellow color to bright red, as such polymer beads form a tris(trifluoromethyl)stibine-pyridine complex. Such colorimetric change is immediately visible to the eye, and is extremely rapid in exposure to the tris(trifluoromethyl)stibine gas. Such tris(trifluoromethyl)stibine-pyridine complex is irreversibly formed, and even prolonged heating under vacuum does not alter the bright red color of the exposed beads.

The poly(vinyl pyridine) material may alternatively be in the form of a film, which provides a “record” of the gas exposure to the tris(trifluoromethyl)stibine target gas by the irreversibly changed (red) color.

Similar results are achievable for other metal hydride gas species, e.g., arsine, phosphine, stibine, stannane, etc., and the colorimetric indicator element can be of any other suitable polymeric or other material having a color-change capability in exposure to the target gas species.

In the use of polymeric film elements as colorimetric indicators, a polymer film may require speciation for a particular gas or be modified to contain a reactive additive for formation of a colored complex with the hydride or other target gas species. Use of highly colored metal complexes as additives to polymeric films may be utilized, or formation of highly colored reactive by-products of target gas exposure may be preferred as a modality for detection.

By providing a film, strip, patch, or other article having an irreversible color-change capability in exposure to the target gas species, either by color change native to the material of construction, or as provided by an additive therein and/or thereon, the colorimetric indicator element provides a “permanent” record article reflecting the incursion of the target gas species in an environment being monitored. In this manner, the deficiency of prior art detectors having no “visual history” capability is overcome by a simple sensing element that may be readily employed in a gas monitoring operation for detection of one or more target gas species in the gaseous environment being monitored.

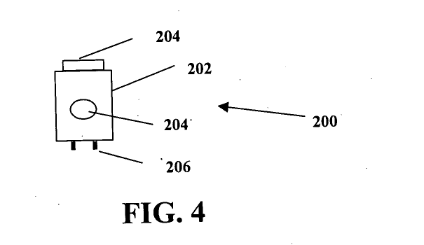

FIG. 4 is a schematic representation of an electrochemical cell 200 featuring a colorimetric indicator element according to one aspect of the invention. The electrochemical cell 200 includes a housing 202. At the top distal end of the cell in the view shown, a sensor aperture 204 is arranged to admit gas from the ambient environment of the device. The housing 202 contains a sensing mechanism (not shown in FIG. 3) that is connected to electrical leads 206 which are in turn coupled to suitable signal processing means such as a microprocessor, central processing unit, digital circuitry, etc.

On the housing 202 of the electrochemical cell 200 is a colorimetric indicator patch 204, e.g., as adhesively attached to the exterior surface of the housing with a low-tack adhesive medium, or secured to the housing in other suitable manner. The colorimetric indicator patch 204 can be formed of a thin film polymeric material that is colorimetrically sensitive to a target gas species, such as a hydride or acid gas, and is effective in exposure to such target gas species, to change color. By such arrangement, the colorimetric indicator patch serves as an adjunct to the electrochemical cell, to provide a “quick-read” capability to the electrochemical cell that the gaseous environment being monitored by the cell has been contaminated with the target gas species, as evidenced by the color change.

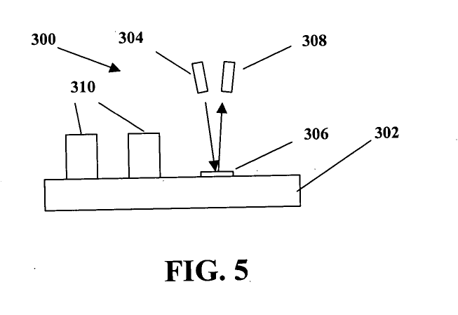

FIG. 5 is a schematic representation of a gas detection module 300 including an array of electrochemical cells 310 and a photodiode/colorimetric indicator element assembly, in accordance with another aspect of the invention. The gas detection module 300 includes a base member 302 on which the electrochemical cells 310 are mounted. The base member 302 also has a colorimetric indicator element 306 mounted thereon, and arranged in light-receiving relationship to a light source 304.

The light source 304 can be of any suitable type, including monochromatic light sources, polychromatic light sources, infrared radiation sources, UV radiation sources, lasers, etc., as appropriate to the specific colorimetric indicator element 306 being employed. The light impinged on the colorimetric indicator element 306 produces a reflected light signal that is transmitted from the colorimetric indicator element 306 to the photodetector 308. The photodetector 308 can likewise be of any suitable type, e.g., a photodiode, a photoscintillation detector, a CCD element, a phosphor luminescent detector, etc., as appropriate to the light source 304 and the colorimetric indicator element 306 that is employed.

The systems shown in FIGS. 4 and 5 thus utilize the colorimetric indicator element of the invention as a supplemental detection means, to provide (i) redundant gas sensing capability, and (ii) an independent quick-action sensor that is permanently indicative of a target gas species incursion event.

While the invention has been described hereinabove with reference to specific features, aspects and embodiments, it will be recognized that the utility of the invention is not thus limited, but rather extends to and encompasses other modifications, variations and alternative embodiments, as will readily suggest themselves to those of ordinary skill in the art, based on the disclosure herein. Accordingly, the invention is to be broadly interpreted and construed, as being inclusive of all such variations, modifications and alternative embodiments, within the spirit and scope of the claims hereinafter set forth.

1. A windowed chamber comprising a radiation-transmissive window, and interiorly disposed within the chamber at least one of:
(i) a radiation-transmissive protective film on an interior surface of said window, and
(ii) a colorimetric medium disposed in viewable relationship to said window, wherein the colorimetric medium undergoes a color change in the presence of target gas species.

2. The windowed chamber of claim 1, wherein said chamber comprises a semiconductor manufacturing process chamber.

3. The windowed chamber of claim 2, wherein said semiconductor manufacturing process chamber comprises a deposition chamber.

4. The windowed chamber according to claim 2, wherein said semiconductor manufacturing process chamber comprises an effluent treatment chamber.

5. The windowed chamber of claim 4, wherein the effluent treatment chamber comprises a scrubber.

6. The windowed chamber of claim 5, wherein the scrubber comprises a dry scrubber.

7. The windowed chamber of claim 1, comprising a radiation-transmissive protective film on an interior surface of said window.

8. The windowed chamber of claim 7, wherein said film comprises a polymeric film.

9. The windowed chamber of claim 7, wherein said film is transmissive to radiation of a type selected from the group consisting of visible radiation, IR radiation and UV radiation.

10. The windowed chamber of claim 7, wherein said film comprises a visible radiation-transmissive film.

11. The windowed chamber of claim 7, wherein said film comprises a material selected from the group consisting of acrylics, vinyls, silicones, polycarbonate, polysulfone, acetates and styrenes.

12. The windowed chamber of claim 7, wherein the film comprises a pre-formed film.

13. The windowed chamber of claim 7, wherein the film comprises a form-in-place film.

14. The windowed chamber of claim 7, wherein the film has a thickness of a range of from about 2 to about 100 mils.

15. The windowed chamber of claim 7, wherein said film comprises a gel coating.

16. The windowed chamber of claim 7, wherein said film is secured to the interior surface of the window by a securement means selected from the group consisting of static charge affixation, friction fit, adhesive bonding, mechanical fixturing, intrinsic adhesion, and associative bonding.

17. The windowed chamber of claim 7, wherein the interior surface and said film are associatively bonded to one another.

18. The windowed chamber of claim 17, wherein the interior surface of the window is chemically functionalized for said associative bonding.

19. The windowed chamber of claim 7, wherein the film is manually peelable from the interior surface of the window.

20. The windowed chamber of claim 1, comprising a colorimetric medium disposed in viewable relationship to said window.

21. The windowed chamber of claim 20, wherein the chamber comprises a semiconductor manufacturing process chamber.

22. The windowed chamber of claim 20, wherein the chamber comprises a wet scrubber.

23. The windowed chamber of claim 20, wherein the chamber comprises a dry scrubber.

24. The windowed chamber of claim 20, wherein the chamber comprises a thermal reactor.

25. The windowed chamber of claim 20, wherein the chamber comprises a scrubber.

26. The windowed chamber of claim 23, wherein said dry scrubber chamber contains a bed of scrubber medium effective to abate acid gas species and/or hydride gas species.

27. The windowed chamber of claim 26, wherein the scrubber medium is effective for removal of at least one gas species selected from the group consisting of hydrogen chloride, boron trichloride, boron trifluoride, hydrogen fluoride, arsine, phosphine, germane, boranes, stibine, silanes and alkylsilanes.

28. The windowed chamber of claim 26, wherein the colorimetric medium comprises an acid gas-reactive chemistry including a colorimetric species selected from the group consisting of iron oxide, calcium hydroxide, copper sulfate, copper hydroxide and copper carbonate.

29. The windowed chamber of claim 20, wherein the colorimetric medium comprises a sheet or web form article impregnated with colorimetric chemistry effective in exposure to a target gas species to undergo a color change.

30. The windowed chamber of claim 20, wherein the colorimetric medium is coated on a substrate.

31. The windowed chamber of claim 30, wherein the substrate comprises material selected from the group consisting of alumina, silica, molecular sieves, clays and macroreticulate polymers.

32. The windowed chamber of claim 20, wherein the colorimetric medium comprises a porous paper element impregnated with colorimetric chemistry.

33. The windowed chamber of claim 32, wherein the colorimetric chemistry comprises an impregnated species selected from the group consisting of iron oxide, calcium hydroxide, copper sulfate, copper hydroxide and copper carbonate.

34. The windowed chamber of claim 20, wherein the colorimetric medium is reposed on the interior surface of the window.

35. The windowed chamber of claim 20, wherein the colorimetric medium comprises a porous paper impregnated with colorimetric chemistry and disposed in a cartridge.

36. A monitoring apparatus having a radiation-transmissive window for transmission therethrough of radiation from a monitored environment, and circuitry for processing radiation transmitted through the window and generating a correlative output, such window having on a surface thereof exposed to the monitored environment, a radiation-transmissive protective film that is selectively removable from the window.

37. The monitoring apparatus of claim 36, wherein the radiation comprises a radiation type selected from the group consisting of visible, infrared and ultraviolet radiation.

38. The monitoring apparatus of claim 36, wherein the radiation comprises visible radiation.

39. The monitoring apparatus of claim 36, wherein said film comprises a polymeric film.

40. The monitoring apparatus of claim 36, wherein said film comprises a material selected from the group consisting of acrylics, vinyls, silicones, polycarbonate, polysulfone, acetates and styrenes.

41. A colorimetric indicating assembly for colorimetric detection of target gas species in a gaseous environment containing same, said assembly comprising a viewing window having disposed in viewable relationship thereto a colorimetric medium that in exposure to the target gas species changes color.

42. The assembly of claim 41, wherein the colorimetric medium comprises a porous paper element impregnated with a colorimetric chemistry providing a color change in exposure of the colorimetric medium to the target gas species in the gaseous environment.

43. A method of reducing maintenance of a windowed port exposed to a gaseous environment on a first surface of a window, said method comprising providing a protective film on said first surface of said window, said protective film being selectively removable from the window surface.

44. A method of monitoring a gaseous environment for detection of a target gas species therein, said method comprising disposing a viewing window in viewing relationship to the gaseous environment and disposing a colorimetric medium in the gaseous environment in viewable relationship to the window.

45. A gas detector assembly including a sheet-form element impregnated with a colorimetric medium that responsively changes color in exposure to one or more target gas species, and means for detecting such color change when the sheet-form element has changed color in exposure to such one or more target gas species.

46. A method of detecting the presence of one or more target gas species in an environment susceptible to the presence of such gas species, in which the method involves disposing a sheet-form element in the environment, wherein the sheet-form element is impregnated with a colorimetric chemistry that is effective to change color of the sheet-form element when the impregnated sheet-form element is exposed to the one or more target gas species.

47. A window exposed to a gaseous environment susceptible to incursion of target gas species in use, said window having on a surface thereof exposed to the gaseous environment a removable protective film having a colorimetric medium associated therewith, wherein the colorimetric medium undergoes a color change in exposure to the target gas species.

48. A gas detection article comprising a polymeric material that is colorimetrically responsive to presence of at least one target gas species, whereby exposure of the polymeric material to such at least one target gas species causes a color change of the polymeric material.

49. A method of detecting the presence of one or more target gas species in an environment susceptible to the presence of such gas species, in which the method involves exposing to such environment a gas detection article comprising a polymeric material that is colorimetrically responsive to presence of at least one target gas species, whereby exposure of the polymeric material to such at least one target gas species causes a color change of the polymeric material.
